(19) United States
(12) Patent Application Publication
(10) Pub. No.: US 2022/0389594 A1
(43) Pub. Date: Dec. 8, 2022

(54) METHOD AND EQUIPMENT FOR THE CONTINUOUS CLEANING OF A MOVING STEEL STRIP

(71) Applicant: ArcelorMittal, Luxembourg (LU)

(72) Inventors: Pierre RICHET, Metz (FR); Forent SPONEM, Vigy (FR)

(21) Appl. No.: 17/774,028

(22) PCT Filed: Nov. 5, 2019
(86) PCT No.: PCT/IB2019/059489

§ 371 Date: May 3, 2022

(51) Int. Cl. C23G 3/02; B08B 3/04; B08B 3/12

(52) U.S. Cl. CPC C23G 3/021; C23G 3/026; B08B 3/041; B08B 3/123; B65G 49/02

(57) ABSTRACT

A continuous cleaning installation 1 of a passing strip S includes a tank 2, an aqueous solution 3 inside the tank 2. It also includes at least a roll 4 immerged in the aqueous solution 3, at least an ultrasound emitter 5, a feed for feeding 6 an aqueous solution and emptying 7 the tank. Moreover, it also includes and estimator for estimating 8 the aqueous solution level, a calculator for calculating 9 for each ultrasound emitter 5 its distance to the aqueous solution level and a controller for controlling the power 10 of the at least one ultrasound emitter 5 and at least an impermeable closable opening 11 on at least a lateral side of the tank through which the at least one ultrasound emitter 5 can pass.

The present invention relates to a cleaning tank comprising at least transducer one for continuously cleaning a strip. Such an invention improves the cleaning efficiency of the cleaning process.

### BACKGROUND

In the metallurgical field, producing strip having a high surface quality is of a major importance. During the rolling step, iron, metallic particles, dirt and grease adhere to the metal strip. Such adhesions engender a degradation of the strip surface quality post-coating because they will be entrapped under the coating and thus the surface will not be smooth. In order to avoid such drawbacks, the strip is cleaned before the coating step. Generally, such cleaning occurs after the rolling operation and before the annealing or the coating. To do so, most of the cleaning lines use an electrolytic process among their cleaning operations. However, such a technique presents a high safety risk due to H₂ accumulation, leading to safety hazards such as fire. Consequently, cleaning lines using ultrasound have been developed to replace the electrolytic process.

### SUMMARY OF THE INVENTION

Ultrasound cleaning works thanks to the propagation of an ultrasound wave (or more generally an acoustic wave) through an aqueous solution which induces local variations of the aqueous solution pressure. When the negative pressure is low enough (lower than the aqueous solution vapour pressure), the aqueous solution cohesive forces break down, and gas bubbles (also called cavitation bubbles) are formed. These bubbles are then submitted to pressure variations (due to acoustic wave propagation), which cause them to expand and contract successively until they collapse. Ultrasonic waves induce a thermal effect, but also a mechanical effect due to cavitation. Indeed, two phenomena occur when cavitation bubbles break down:
shock waves due to the violent compression of the gas present in the bubble,
micro-jets: near a solid surface, the bubble implosion becomes dissymmetrical and the resulting shock wave produces aqueous solution micro-jets that are directed toward the solid surface. The impacts of the micro-jets on the solid surface are energy-rich, and this mechanical effect can be used in galvanization for the cleaning of the strip surface after cold rolling.

Patent KR 2005 006 3155 discloses an apparatus cleaning a steel sheet. Said steel sheet is passed through a tank filled with an alkaline solution in which ultrasound emitting boxes or crates are placed on each side of the passing sheet. Those ultrasound emitting boxes comprise ultrasound emitting means, such as piezo-electric transducers, stuck on the crate sides. When the piezo-electric transducers vibrate, the vibration is transmitted to the crate sides and then to the solution. Consequently, ultrasound waves are propagated in the cleaning bath and onto the strip. It increases the cleaning efficiency.

However, by using the above method and its equipment, the cleaning efficiency is not optimal.

It is an object of the present invention to provide a solution solving the aforementioned problems.

The present invention provides an equipment (1) for the continuous cleaning of a moving steel strip (S) comprising:
a tank (2) containing an aqueous solution (3),
at least a roll (4) for guiding said strip into said tank (2),
at least a transducer (5) immerged in the aqueous solution.

The present invention further provides a method for cleaning a moving strip in a cleaning installation comprising a tank (2) containing an aqueous solution (3), at least a roll (4) for guiding said strip into said tank (2), at least a transducer immerged in the aqueous solution comprising the steps of
immerging said moving strip into said aqueous solution (3),
emitting ultrasound, into said aqueous solution, by said at least one transducer immerged in the aqueous solution.

### BRIEF DESCRIPTION OF THE DRAWINGS

Other characteristics and advantages of the invention will become apparent from the following detailed description of the invention.

To illustrate the invention, various embodiments and trials of non-limiting examples will be described, particularly with reference to the following figure:

FIGS. 1A and 1B exhibit a lateral and a front view of an embodiment of a tank equipped with transducers.

FIGS. 2A and 2B exhibit a lateral and a top view of a second embodiment of a tank equipped with transducers.

FIGS. 3A and 3B show two embodiments of transducers.

FIGS. 4A and 4B exhibit two embodiments of means to support the transducers.

FIG. 5 shows a preferred arrangement of the transducers and the associated waves.

FIG. 6 shows the effect of the type of ultrasound emitting means on the cleaning efficiency.

### DETAILED DESCRIPTION

The invention relates to an equipment 1 for the continuous cleaning of a moving steel strip S comprising:
a tank 2 containing an aqueous solution 3,
at least a roll 4 for guiding said strip into said tank 2,
at least a transducer 5 immerged in the aqueous solution 3.

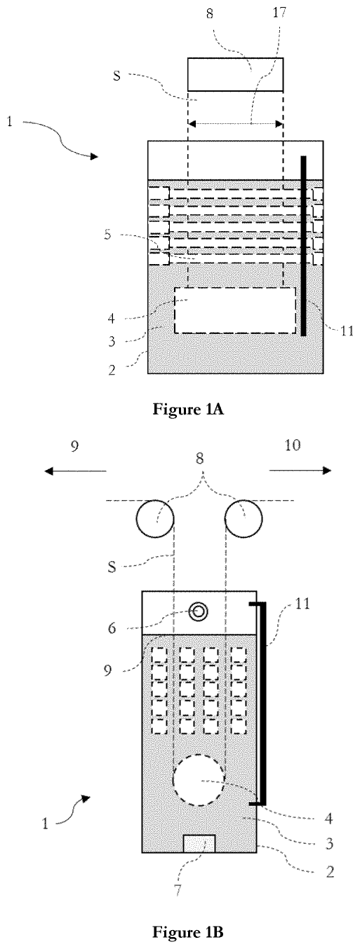

FIG. 1A is a lateral view and FIG. 1B is a front view of the continuous cleaning installation. As illustrated in FIGS. 1A and 1B, the continuous cleaning installation 1 of a moving strip S comprises a tank 2, an aqueous solution 3 inside said tank. It also comprises at least a roll 4 immerged in said aqueous solution 3 and at least a transducer 5. The aqueous solution can contain an alkali product or an acidic solution or a neutral solution to improve the cleaning efficiency. The solution selection depends on the substrates and the pollutants.

The tank can also comprise means for feeding 6 an aqueous solution into the tank and emptying 7 the tank.

As illustrated in FIG. 1A, the feeding means 6 are preferentially situated in the upper portion of the tank or at the top of the tank allowing a better filling of the tank, so the cleaning time and the distance passed by the strip through the aqueous solution is increased. The emptying means 7 are placed in the lower portion of the tank and preferentially at its bottom in order to empty the tank as much as possible, such means can be pipes and valves connected to a dump, a recycling or a regenerating process.

The at least one roll 4 is preferentially at the bottom of the tank but above the emptying means 7, such an arrangement increases the distance travelled by the strip S through the aqueous solution 3 and the cleaning time thus improving the cleaning.

The aqueous solution 3 is introduced into the tank by the feeding means 6 such as pipes and valves, preferentially connected to another tank filled with the solution (not represented).

As illustrated in FIG. 1A, the cleaning installation 1 preferably comprises at least two external rolls 8 placed above said tank 2, at least one on each side of the tank e.g.: one on the upstream side 9, the other one on the downstream side 10 of the ultrasonic cleaning installation. The rolls 8 and 4 have preferentially the same orientation, e.g. their rotation axes are parallel. The rolls positioning should preferably allow the strip S to pass through the aqueous solution 3 without being twisted.

Moreover, it can also comprise means for estimating 11 the aqueous solution level. The means for estimating 11 the aqueous solution level can be a differential pressure captor, vibrating level switches or any means used in a hydrostatic method.

The at least one transducer 5 is placed inside said tank 2 preferably under the feeding means 6 and preferably above the roll 4.

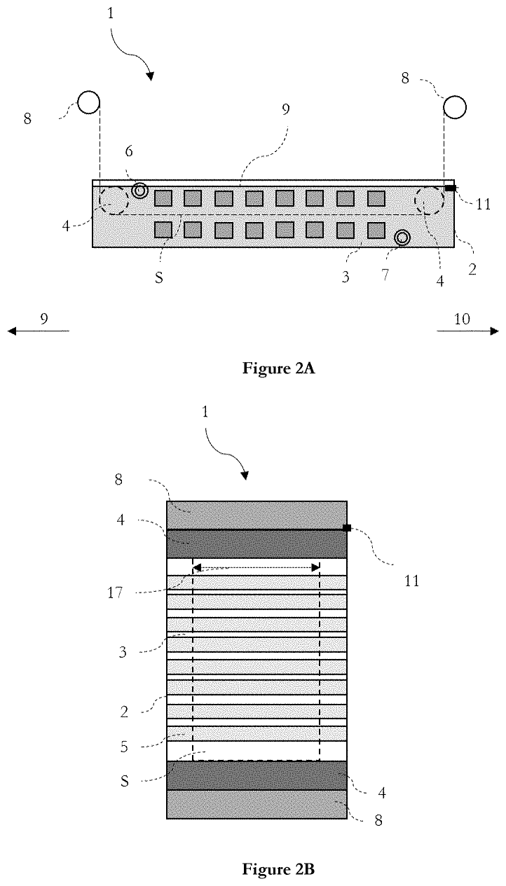

FIGS. 2A and 2B exhibit the lateral and top view of a second preferred embodiment of the continuous cleaning installation in which the strip S is majorly moved horizontally through the aqueous solution compared to the FIGS. 1A and 1B where the strip S is majorly passed vertically.

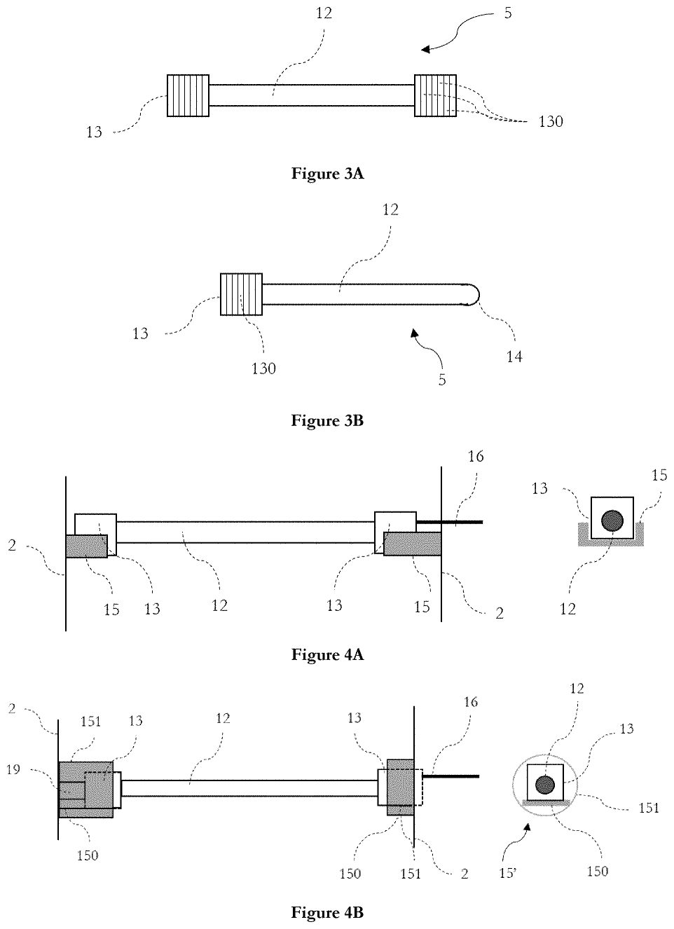

The transducer 5, as illustrated in FIGS. 3A and 3B, is made of a resonator rod 12 having at either one or both extremities a driverhead 13, such as push-pull piezo transducers. Said driverhead 13 generally comprises several piezoelectric transducers 130. The resonator rod 12 vibrates thanks to the at least one driverhead 13. Such a system emits omnidirectionally ultrasound. When the transducer comprises only one driverhead, the other extremity 14 is preferably round or pointy as illustrated in FIG. 3B.

As illustrated in FIGS. 4A and 4B, the transducers 5 are preferably supported by the tank wall 2 or support pieces 15, 150 and 151 fixed to the tank wall. Preferably, the electric wires 16 connected to said driverheads 13 pass through the tank wall 2 and are not immerged in nor in contact with the aqueous solution.

The transducers work is able to work at a frequency between 20 and 60 kHz. Preferably, the transducers work at a frequency of at least 25 kHz. Preferably, the transducers work at a maximum frequency of 40 kHz. Each transducer is preferably able to work at a power of 500 to 3 000 kW. Even more preferably, each transducer has a power of at least 2 000 kW.

During the cleaning process, the bath level can vary to a point where a transducer is not immerged anymore, and in that case it is preferable to turn off the non-immerged resonator to avoid damage due to overheating. During maintenance operation, the tank can be emptied, and in that case it is preferable to turn off the resonator to avoid damage due to overheating. Overall, when a resonator is not immerged at least 3 cm below the aqueous solution surface, it is preferable to turn it off to lower the risk of damage due to overheating.

A cleaning tank according to the invention, comprising at least a transducer, permits to improve the cleaning efficiency compared to the cleaning tank as known in the art, comprising immerged boxes with ultrasonic emitter means having the same working frequency.

Several tests have been done to demonstrate the improved efficiency of a cleaning tank equipped with transducers, such as push-pull transducers, compared to one equipped with submersible boxes. In those tests, the cleanliness of a strip sample has been measured before and after a cleaning step. In those experiments, a strip is immersed during 24 sec in a box containing a cleaning bath, having 10 g·L⁻¹ of NaOH, at 65° C. and either a set of two push-pull piezo transducers having a power of 2 kW or a submersible box having a power of 2 kW. It is assumed that an immersion time of 24 seconds in the experiment conditions corresponds to a direct exposition time of about 6 seconds because a strip portion is faced by an ultrasound emitter means only during a quarter of the experiment time due to its displacement through the aqueous solution.

The cleaning efficiency, as noted in the following table, is: “the estimated cleanliness before the cleaning step” divided by “the estimated cleanliness after the cleaning step”. To estimate the cleanliness, a 3M 595 Scotch™ adhesive is pressed on a strip surface in order to stick the iron fines and the oil onto the adhesive. Then the reflectance of the scotch is measured by a reflectometer. This reflectance is linked to the density of iron fines per square meter. The more iron fines that have adhered to the adhesive, the lower will be its reflectance. Consequently, the higher is the adhesive reflectance, the cleaner is the strip. The following table contains the main parameters of the experiment. In FIG. 6, the cleaning efficiency is, for various strip speed, plotted for both types of ultrasound emitting means: the push-pull tubes and the submersible boxes.

| | | | Bath | Strip | Immersion | Cleanliness | Cleanliness | Cleaning |
|---|---|---|---|---|---|---|---|---|
| | Frequency | Power | temperature | speed | time | before | after | efficiency |
| Type | (kHz) | (kW) | (° C.) | (m · min⁻¹) | (sec) | cleaning | cleaning | (%) |
| Box | 25 | 2 | 65 | 50 | 24 | 9.50 | 7.00 | 26 |
| PP | 25 | 2 | 65 | 50 | 24 | 9.04 | 4.15 | 54 |
| Box | 25 | 2 | 63 | 100 | 24 | 10.55 | 7.62 | 28 |
| PP | 25 | 2 | 62 | 100 | 24 | 11.99 | 6.02 | 50 |
| Box | 25 | 2 | 64 | 150 | 24 | 10.00 | 8.09 | 19 |
| PP | 25 | 2 | 66 | 150 | 24 | 10.95 | 6.53 | 40 |
| Box | 40 | 2 | 67 | 100 | 24 | 8.51 | 6.61 | 22 |
| PP | 40 | 2 | 67 | 100 | 24 | 10.70 | 7.30 | 32 |

Preferably, all the resonators in functioning are completely immerged at least 3 cm under the solution surface. Such immersion permits lowering of the risk of overheating of the resonators.

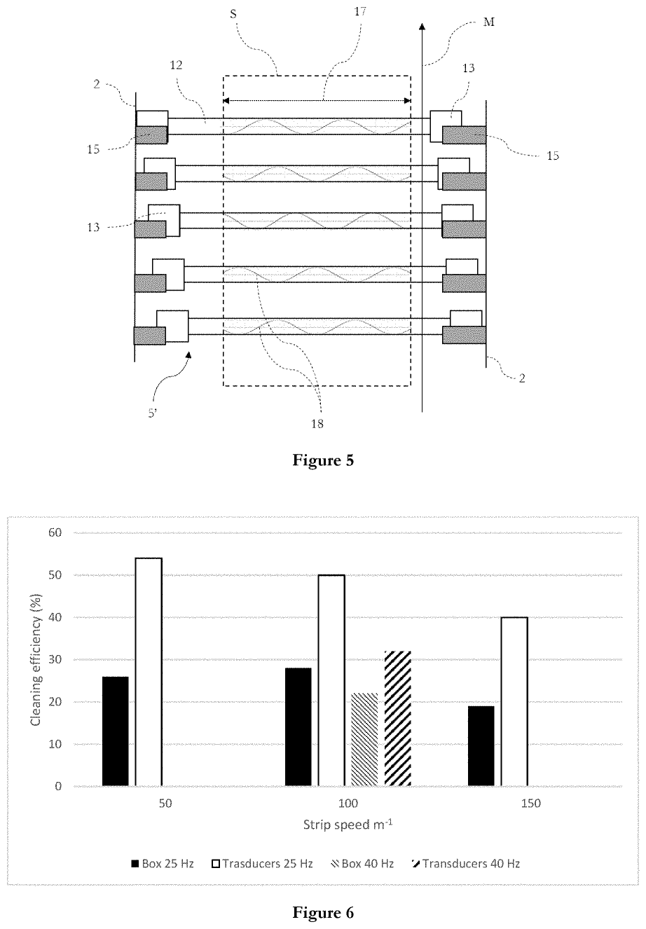

Preferably, as it can be seen in FIG. 5, said transducer 5 has its length parallel to the strip width 17. In other words, the resonator rod 12 has its length parallel to the strip width 17. Even more preferentially, the transducer is positioned parallel to the strip width 17 in a way that it covers the whole strip width. Such an arrangement should improve the cleaning efficiency and the cleaning homogeneity along the strip width.

When the tank comprises at least two transducers having a resonator rod length smaller than the strip width, the resonator rods are shifted in order to cover the whole strip width.

Preferably, as illustrated in FIGS. 1A and 2A, the tank comprises at least two transducers 5. Even more preferably, the tank comprises 5, 10 or 15 transducers.

When there are two transducers on the same side of the strip, they are preferably shifted one from another by a distance corresponding to (0.5) times the wavelength produced by the push-pull transducers. When the number of ultrasound emitting means is equal to m, each of them can be further shifted by a similar distance, (1/m) times the wavelength towards its neighbours. For example, if six transducers working at a frequency of 25 kHz are used in an environment comparable to water, the wave speed, which depends on numerous factors (e.g.: the temperature and the pressure) is approximately of 1500 m·s⁻¹. The wavelength is equal to the wave speed divided by the wave frequency so in this case, 1 500/25 000=0.06, the wavelength is approximately of 6 cm. In the case where the ultrasound emitting means produce ultrasound with a wavelength of 6 cm, they should be laterally shifted of, (1/6)×6=1 cm one from another.

As it can be seen in FIG. 5, such an arrangement prevents having two nodes 18 aligned in the strip moving direction. Such a shift allows improving the cleaning homogeneity, as it ensures that all points of the strip are being exposed to at least one ultrasound wave.

Preferably, the transducers 5 and the strip S are spaced by a distance comprised between 40 mm and 250 mm. Such spacing enables to efficiently use the ultrasound emitters. Such spacing distance improves the installation 1 because if the spacing if less than 40 mm, the ultrasound emitter will eventually be broken by the strip S due for example strip bending or strip flatness irregularities. But if the spacing is bigger than 200 mm then the efficiency of the ultrasound emitters' cleaning power seems to be severely reduced.

Preferably, each surface of said strip S is faced by at least one transducer. Even though an ultrasound emitter placed on one side of a strip cleans both surfaces, having ultrasound emitting means facing each surface increases the cleaning quality. In other words, in an installation similar to the one represented in FIGS. 1A and 1B, at least one transducer 5 is positioned between a tank wall and the strip S and at least one transducer is positioned between a portion of the strip going down and a portion of the strip going up. Similarly, in an installation similar to the one represented in FIGS. 2A and 2B, at least one transducer is placed above and at least one other is placed under the strip.

Preferably, said equipment has a power density between 5 Watt per litre and 25 Watt per litre of unit of volume of said aqueous solution. Even more preferentially, the power per litre is between 10 and 20 Watt per litre. Using a power density in this range seems to be the best compromise between the cleaning efficiency and energy saving, it allows a good and sufficient cleaning of the strip and avoid energy waste.

This invention also relates to a method for cleaning a moving strip in a cleaning installation comprising a tank 2 containing an aqueous solution 3, at least a roll 4 for guiding said strip into said tank 2, at least a transducer 5 immerged in the aqueous solution comprising the steps of
immerging said moving strip into said aqueous solution 3,
emitting ultrasound, into said aqueous solution, with said at least one transducer immerged in the aqueous solution.

Preferably, said aqueous solution contains between 10 grams per litre and 40 grams per litre of alkali product. Apparently, an alkali product concentration in this range improves the cleaning and efficiently uses the alkali product.

Preferably, said aqueous solution is kept at a temperature between 30° C. and 80° C. Apparently, higher is the cleaning solution temperature, better is the cleaning efficiency of the process but shorter is the transducer lifespan. This range seems to be the best compromise between cleaning efficiency and the ultrasound emitter lifespan.

The invention has been described above as to the embodiment which is supposed to be practical as well as preferable at present. However, it should be understood that the invention is not limited to the embodiment disclosed in the specification and can be appropriately modified within the range that does not depart from the gist or spirit of the invention, which can be read from the appended claims and the overall specification, and a manufacturing method of a hot-rolled steel sheet and a manufacturing apparatus of a hot-rolled steel sheet with such modifications are also encompassed within the technical range of the invention.

1-10. (canceled)

11. Equipment for continuously cleaning a moving steel strip, the equipment comprising:
a tank containing an aqueous solution;
at least one roll for guiding the strip into the tank; and
at least one transducer immerged in the aqueous solution.

12. The equipment as recited in claim 11 wherein said at least one transducer has an operating frequency between 20 and 60 kHz.

13. The equipment as recited in claim 11 wherein the at least one transducer has an operating power of 500 to 3 000 kW.

14. The equipment as recited in claim 13 wherein the transducer has is arranged to have a length parallel to the strip width.

15. The equipment as recited in claim 13 wherein the transducer and the strip are spaced by a distance of 40 mm to 250 mm.

16. The equipment as recited in claim 11 wherein each of two primary surfaces of the strip S is faced by at least one of the at least one transducer.

17. The equipment as recited in claim 11 wherein the equipment has a power capacity between 5 Watt per liter and 25 Watt per liter of unit of volume of the aqueous solution.

18. A method for cleaning a moving strip in a cleaning installation having a tank containing an aqueous solution, at least one roll for guiding the strip into the tank, and at least one transducer immerged in the aqueous solution, the method comprising the steps of:
immerging the moving strip into the aqueous solution; and
emitting ultrasound, into the aqueous solution, by the at least one transducer immerged in the aqueous solution.

19. The method as recited in claim 18 wherein the aqueous solution contains between 10 grams per liter and 40 grams per liter of alkali product.

20. The method as recited in claim 18 wherein the aqueous solution is kept at a temperature between 30° C. and 80° C.
